(19) United States
(12) Patent Application Publication
(10) Pub. No.: US 2006/0139487 A1
(43) Pub. Date: Jun. 29, 2006

(54) Method and apparatus for reducing delay in retrieval of a teletext page

(75) Inventors: Changtai (Richard) Liang, Sunnyvale, CA (US); Shijun Deng, San Jose, CA (US)

Correspondence Address: DLA PIPER RUDNICK GRAY CARY US, LLP, 2000 UNIVERSITY AVENUE, E. PALO ALTO, CA, 94303-2248, US

(73) Assignee: Trident Technologies, Inc.

(21) Appl. No.: 11/025,023

(22) Filed: Dec. 29, 2004

(51) Int. Cl. H04N 11/00

(52) U.S. Cl. 348/468

(57) ABSTRACT

Teletext engines configured for specific tasks. One such Teletext engine indexes the page numbers of incoming Teletext pages, along with the addresses at which they are stored in the TV's memory. This index essentially provides a list of stored Teletext pages and their corresponding locations in memory, sorted by page number. In one embodiment, this list is sorted in numerical order of page number, and in another embodiment, the list is sorted according to the order in which the TV receives pages. When the TV is to display a particular Teletext page number, it simply checks the index to find the corresponding address. Armed with this address, the TV can quickly retrieve the correct Teletext page from memory, as it can simply look up the correct address without first conducting a laborious search of the entire memory. Page retrieval times can thus be reduced significantly.

### BRIEF DESCRIPTION OF THE INVENTION

This invention relates generally to television. More specifically, this invention relates to the reduction of delay in retrieving Teletext pages for display on a television.

### BACKGROUND OF THE INVENTION

As a supplement to conventional television (TV) broadcasts, Teletext has been shown to be a valuable source of additional information. Teletext information, which is broadcast to individual TVs in the form of electronic “pages” that contain information for display, is sent as signals modulated in the vertical blank lines (commonly lines 6 to 22) of a conventional TV signal. The pages are then read, stored, and displayed on the TV's screen in addition to the currently displayed TV program. Some Teletext-enabled TVs can currently store up to 2048 pages of information, each page having up to 3979 sub pages. In some applications, Teletext pages are displayed automatically upon receipt. When viewed interactively, individuals can also select particular pages of information that are then recalled from a TV memory and processed for display.

Such Teletext systems do, however, suffer from certain drawbacks. Currently, local TV Teletext memories can be up to one megabyte in size or larger. While this does allow for more pages to be stored, Teletext pages are often recalled by performing a search of the entire memory. Such larger memories thus often produce excessively long search times and, as a result, increase delay between the time of an individual's page selection and the display of that page. Such delays also arise when delayed Teletext pages are automatically refreshed, as the Teletext memory must first be searched to find the refresh page. It is thus desirable to reduce the time required to recall a requested Teletext page, whether the requested page is user-requested or simply intended to refresh the currently displayed page.

### SUMMARY OF THE INVENTION

In one sense, the invention relates to Teletext engines configured for specific tasks. These engines can reside within TV systems, in addition to the TV's local Teletext memory. One such Teletext engine indexes the page numbers of incoming Teletext pages, along with the addresses at which they are stored in the TV's memory. This index essentially provides a list of stored Teletext pages and their corresponding locations in memory, sorted by page number. In one embodiment, this list is sorted in numerical order of page number. In another embodiment, the list is sorted according to the order in which the TV receives pages. Other formats are contemplated, as well. When the TV is to display a particular Teletext page number, it simply checks the index to find the corresponding address. Armed with this address, the TV can quickly retrieve the correct Teletext page from memory, as it can simply look up the correct address without first conducting a laborious search of the entire memory. Page retrieval times can thus be reduced significantly.

Another such Teletext engine checks the page numbers of incoming Teletext pages as they are received, and compares the page numbers to the page number of the Teletext page currently displayed by the TV. A match indicates a new version of the currently-displayed page, which implies that a refresh of the current page is desired. The TV then retrieves the new page's address and displays the new version of the page, thus eliminating the need for a time-consuming search of the Teletext page memory. As with the above-described indexing engine, this “current page engine” also reduces delay in the display of Teletext pages.

The invention can be implemented in numerous ways, including as a method, system, and device. Various embodiments of the invention are discussed below.

As a computer-readable index, one embodiment of the invention comprises, in a television viewing system configured to receive Teletext pages having page numbers, the television viewing system including a processor configured to facilitate the display of the Teletext pages, and a Teletext page storage in electronic communication with the processor and configured to store the Teletext pages at page addresses, a Teletext information index in electronic communication with the processor and configured to index the page numbers and the associated page addresses so as to facilitate determination by the processor of the page address associated with a particular one of the page numbers.

As a television control apparatus, another embodiment of the invention comprises, in a television viewing system configured to receive Teletext pages having page numbers and to display a displayed Teletext page having a displayed Teletext page number, a page number detector configured to detect the page number of a received Teletext page. The television control apparatus also includes a comparison engine in electronic communication with the page number detector, the comparison engine configured to initiate an update of the displayed Teletext page with the received Teletext page if the displayed Teletext page number is equal to the page number of the received Teletext page.

As a method of facilitating the retrieval of Teletext page information, another embodiment of the invention comprises receiving page numbers of Teletext pages, and receiving addresses describing locations at which the corresponding Teletext pages are stored in a memory. The page numbers and the addresses are written to an index that is separate from the memory.

As a method of facilitating an updating of a displayed Teletext page, another embodiment of the invention comprises receiving a received page number of a received Teletext page, and comparing the received page number to a displayed page number of a displayed Teletext page. If the received page number is equal to the displayed page number, an update of the displayed Teletext page with the received Teletext page is initiated.

As a television viewing system, another embodiment of the invention comprises a processor configured to facilitate the display of Teletext pages, and a Teletext page storage in electronic communication with the processor and configured to store the Teletext pages at page addresses. Also included is an index in electronic communication with the processor, the index storing page numbers of the Teletext pages and corresponding ones of the page addresses, so as to facilitate determination by the processor of the page address associated with a particular one of the page numbers.

Other aspects and advantages of the invention will become apparent from the following detailed description taken in conjunction with the accompanying drawings which illustrate, by way of example, the principles of the invention.

### BRIEF DESCRIPTION OF THE DRAWINGS

For a better understanding of the invention, reference should be made to the following detailed description taken in conjunction with the accompanying drawings, in which:

FIG. 1 illustrates a TV system configured to receive and process Teletext pages in accordance with embodiments of the current invention.

FIG. 2 illustrates process steps for receiving and storing Teletext pages and related information in accordance with embodiments of the current invention.

FIG. 3 illustrates process steps for retrieving Teletext pages and related information in accordance with embodiments of the current invention.

FIGS. 4A-4B illustrate an exemplary page number index and sequential index for sorting Teletext page information in accordance with embodiments of the current invention.

Like reference numerals refer to corresponding parts throughout the drawings.

### DETAILED DESCRIPTION OF EMBODIMENTS OF THE INVENTION

The invention pertains to Teletext engines for TV viewing systems. In order to reduce delay in Teletext page retrieval, one engine is provided to index the page numbers of incoming Teletext pages, along with the addresses at which these pages are stored in the TV's memory. When a particular page is desired for display, the address can simply be looked up in the index, eliminating the need to search the entire contents of the TV's memory. The invention also includes the use of a second engine that reduces delay in the updating of a currently-displayed Teletext page. When an incoming page is detected as having the same page number as the currently-displayed Teletext page, this engine notes the address of this incoming page (typically by checking the index generated by the first engine) and informs the system accordingly. The TV can then look up the incoming page directly, rather than searching the TV's memory.

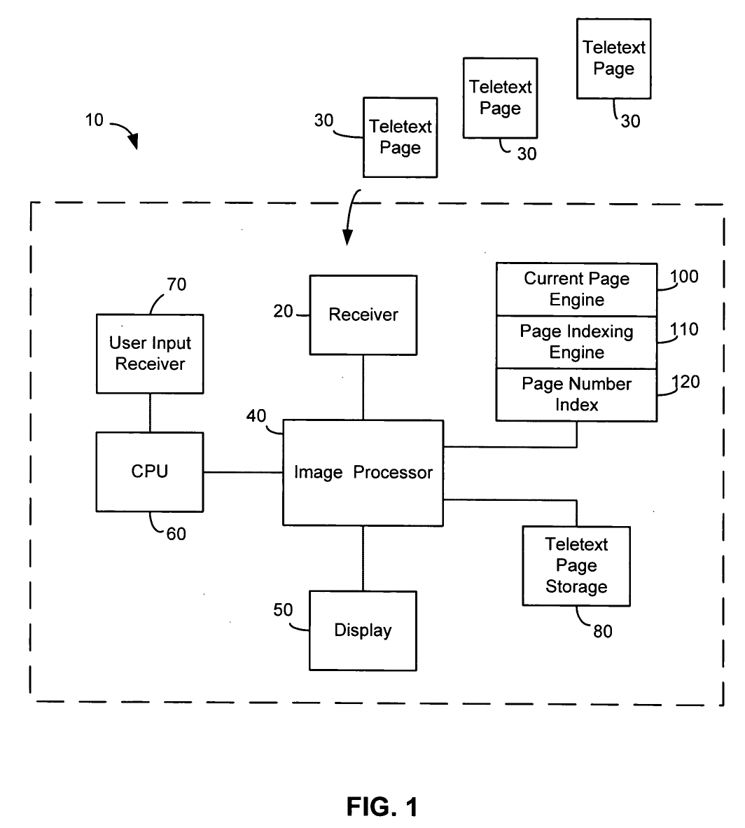

To further explain the operation of these Teletext engines, FIG. 1 illustrates a TV system configured to receive and process Teletext pages in accordance with embodiments of the current invention. A TV viewing system 10 includes a receiver 20 for receiving Teletext pages 30 that can be transmitted to the TV viewing system 10 in known manner. The receiver 20 is in electronic communication with an image processor 40 that processes signals, including received Teletext pages 30, for display upon the display 50. The display 50 can be any device for conveying an image to viewers, such as a cathode ray tube (CRT)—or light emitting diode (LED)—based display. The processor 40 is controlled by a central processing unit (CPU) 60 that can take commands from a user input receiver 70 such as a receiver for remote control signals.

The TV viewing system 10 stores received Teletext pages 30 in a local Teletext page memory 80. However, as mentioned above, searches of this memory 80 can be time consuming when the memory 80 is large. To reduce delay, the TV viewing system 10 also includes a Teletext engine block 90. This block 90 in turn includes two engines and at least one index. The first engine is a current page engine 100 for reducing the time required to refresh currently-displayed Teletext pages 30, and the second is a page indexing engine 110 for reducing the time required for retrieval of a Teletext page 30 from memory 80. A page number index 120 is also included to support both these engines.

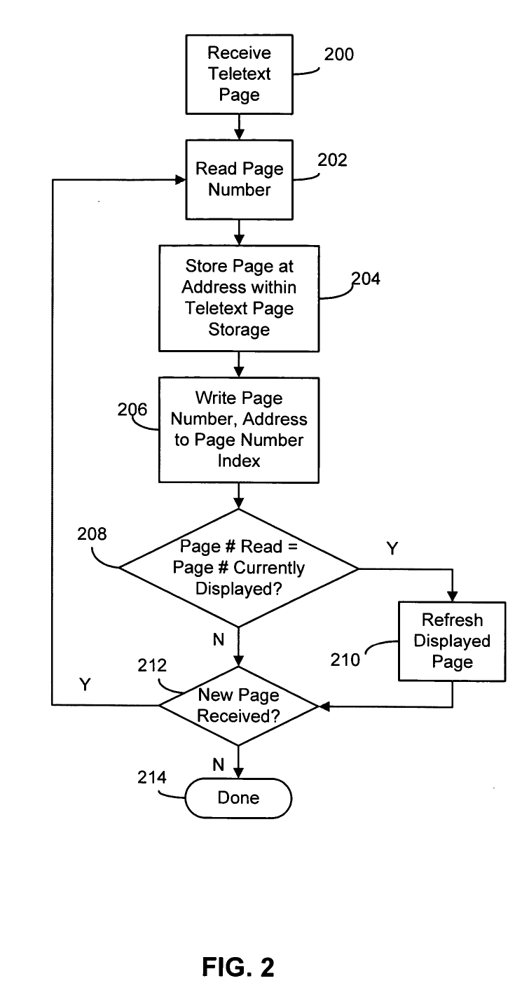

FIG. 2 illustrates further details of how the Teletext engine block 90 reduces delay in displaying Teletext pages. In operation, as Teletext pages 30 are received by the receiver 20 (step 200), their page numbers are read and transmitted to the current page engine 100 and the page indexing engine 110 (step 202). The page is also stored in the Teletext page storage 80, at a particular address (step 204). This address is then sent to the page indexing engine 110, which indexes the address along with the page number (step 206) for quick reference.

In this manner, the page indexing engine 110 builds an index 120 of page numbers and their associated addresses. Accordingly, whenever the image processor 40 needs to retrieve a particular page from the Teletext page storage 80, it checks the index 120 to determine its address, and retrieves the page from that address. Because the index 120 is simply a list of page numbers and their addresses, and does not contain the actual pages themselves, the index 120 is typically much smaller than the Teletext page storage 80 and can be searched much more quickly. Also, if the page numbers and addresses are stored in an order that is known to the image processor 40, a search of the index 120 may not be needed, and address retrieval can be even faster still. The invention thus locates Teletext pages by a quick search of a relatively small index 120, instead of a more time-intensive search of the entire storage 80. Page retrieval time, and thus the time to display Teletext pages, is thus reduced.

In addition to building an index via the page indexing engine 110, the current page engine 100 compares this page number to the page number of the page that the display 50 is currently displaying (step 208). If the page numbers match, the image processor 40 is instructed to retrieve the address of this newly-received page from the index 120, go to this address and retrieve the page, then refresh the displayed page accordingly (step 210). The process continues on in this fashion (step 212), repeating steps 202-210 for subsequent pages, and terminating (step 214) when no further pages are to be received.

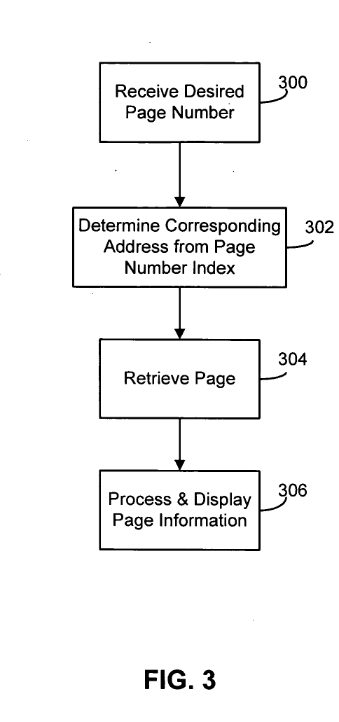

While FIG. 2 partly details the construction of an index 120, FIG. 3 illustrates further details of page retrieval processes employing this index 120. Page retrieval is often initiated by viewers of the TV viewing system 10, who can request desired information remotely. The remote signals are received by the user input receiver 70 and transmitted to the CPU 60. The CPU then processes this request and instructs the image processor 40 (step 300) to display a particular page (identified by its page number). The image processor 40 then checks the index 120 to determine the address corresponding to that page number (step 302). As above, because the index 120 is typically smaller than the Teletext page storage 80, and/or because information is stored in a known order, the determination of address information is much faster than a search of the entire storage 80. Once the address is retrieved from the index 120, the page can be retrieved from storage 80 (step 304). Similar to step 302, this step is also performed much faster than a search of the storage 80, as the page address is already known. The retrieved page can then be processed and displayed by the image processor 40 (step 306).

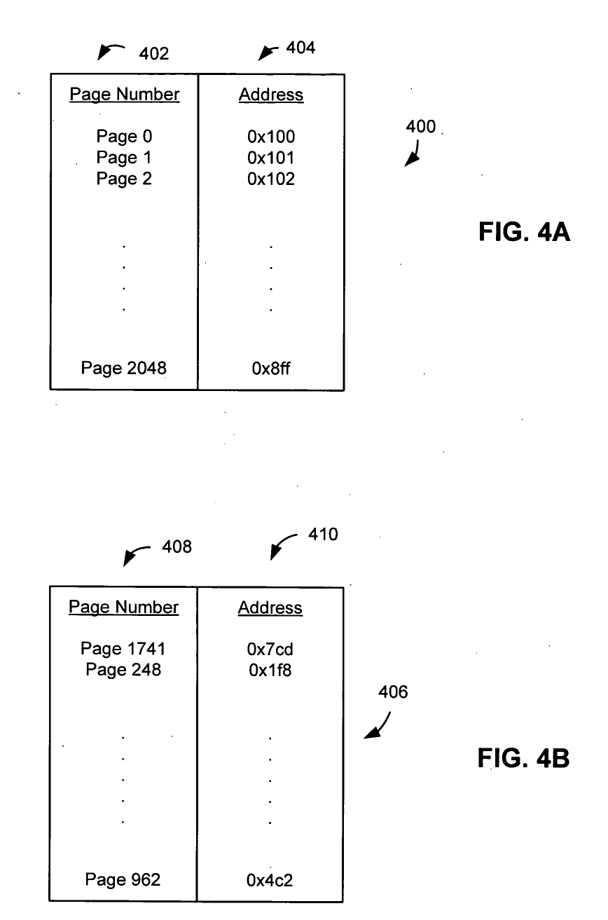

It should be noted that the invention does not limit itself to any particular format for the index 120, but instead contemplates indexes 120 that contain page number and address information stored in any format that facilitates rapid address retrieval. FIGS. 4A-4B illustrate two exemplary formats for the index 120. In FIG. 4A, the index 400 stores information according to numerical order of page number. Specifically, a page number column 402 stores page numbers in ascending numerical order, and an address column 404 stores the corresponding addresses of those page numbers. For example, the page number column 402 stores page number 1 in its second row, and 0x01, its address in storage 80, in the second row of the address column 404. Such an ordered storage can assist in rapid address retrieval. If the image processor 40 knows that page numbers are stored in the page number column 402 in numerical order, it can simply move down the appropriate number of rows, and retrieve the address at that row in address column 404.

As the invention is not limited to the storage of information according to numerical order of page number, FIG. 4B illustrates an index 406 that stores information sequentially, according to the order in which pages 30 are received. That is, as pages 30 are received, their page number and address information are simply appended to the index 406. Thus, while information is not stored in order of page number, an image processor 40 can be configured to note the sequence in which pages 30 have been received. Retrieving address information from the address column 410 is then simply a matter of moving the appropriate number of rows down the page number column 408 and retrieving the corresponding address. Similarly, the image processor 40 can simply search the page number column 408 for the desired page number, and retrieve the address from the corresponding row in the address column 410. Such a search typically involves merely searching a maximum of 2048 numbers, which can be executed much faster than a search of the contents of 2048 pages.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, index 120 can store page number and/or address information in any format that lends itself to rapid information retrieval. Also, the processes of the invention can be user-initiated, or initiated automatically by the TV or another system. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-readable index for use in a television viewing system configured to receive Teletext pages having page numbers, the television viewing system including a processor configured to facilitate the display of the Teletext pages, and a Teletext page storage in electronic communication with the processor and configured to store the Teletext pages at page addresses, the index comprising:
a Teletext information index in electronic communication with the processor and configured to index the page numbers and the associated page addresses so as to facilitate determination by the processor of the page address associated with a particular one of the page numbers.

2. The computer-readable index of claim 1 wherein the Teletext pages have image information for display of an image, wherein the Teletext page storage is configured to store the image information, and wherein the Teletext information index is further configured to index the page numbers and the associated page addresses so as to facilitate rapid retrieval of the image information from the Teletext page storage.

3. The computer-readable index of claim 2 wherein the Teletext information index is a page number index further configured to store the page numbers in numerical order.

4. The computer-readable index of claim 2 wherein the Teletext information index is a sequential index further configured to store the page numbers in the order in which corresponding ones of the Teletext pages are received by the television viewing system.

5. A television control apparatus for use in a television viewing system configured to receive Teletext pages having page numbers and to display a displayed Teletext page having a displayed Teletext page number, the apparatus comprising:
a page number detector configured to detect the page number of a received Teletext page; and
a comparison engine in electronic communication with the page number detector, the comparison engine configured to initiate an update of the displayed Teletext page with the received Teletext page if the displayed Teletext page number is equal to the page number of the received Teletext page.

6. The television control apparatus of claim 5 wherein the comparison engine further comprises a memory configured to store the displayed Teletext page number.

7. The television control apparatus of claim 5 wherein the television viewing system further comprises a processor configured to facilitate the display of the Teletext pages, and a Teletext page storage in electronic communication with the processor and configured to store the Teletext pages at page addresses, the apparatus further comprising a Teletext information index in electronic communication with the processor and configured to index the page numbers and the associated page addresses so as to facilitate determination by the processor of the page address associated with a particular one of the page numbers.

8. The television control apparatus of claim 7 wherein the Teletext pages have image information for display of an image, wherein the Teletext page storage is configured to store the image information, and wherein the Teletext information index is further configured to index the page numbers and the associated page addresses so as to facilitate rapid retrieval of the image information from the Teletext page storage.

9. The television control apparatus of claim 8 wherein the Teletext information index is a page number index further configured to store the page numbers in numerical order.

10. The television control apparatus of claim 8 wherein the Teletext information index is a sequential index further configured to store the page numbers in the order in which corresponding ones of the Teletext pages are received by the television viewing system.

11. A method of facilitating the retrieval of Teletext page information, comprising:
receiving page numbers of Teletext pages;
receiving addresses describing locations at which the corresponding Teletext pages are stored in a memory; and
writing the page numbers and the addresses to an index that is separate from the memory.

12. The method of claim 11 further comprising:
retrieving the addresses from the index according to respective ones of the page numbers; and
retrieving the corresponding Teletext pages from the addresses in the memory.

13. The method of claim 11 wherein the writing further comprises writing the page numbers to the index in numerical order.

14. The method of claim 11 wherein the writing further comprises writing the page numbers to the index in the order in which the page numbers are received.

15. A method of facilitating an updating of a displayed Teletext page, comprising:
receiving a received page number of a received Teletext page;
comparing the received page number to a displayed page number of a displayed Teletext page; and
if the received page number is equal to the displayed page number, initiating an update of the displayed Teletext page with the received Teletext page.

16. The method of claim 15 further comprising:
receiving an address describing a location at which the received Teletext page is stored in a memory; and
writing the received page number and the address to an index that is separate from the memory.

17. The method of claim 16 further comprising:
retrieving the address from the index according to the received page number; and
retrieving the received Teletext page from the addresses in the memory.

18. The method of claim 16 wherein the index has a plurality of page numbers stored in a numerical order, and wherein the writing further comprises writing the received page number to the index in accordance with the numerical order.

19. The method of claim 16 wherein the index has a plurality of page numbers stored in the order in which the page numbers are received, and wherein the writing further comprises appending the received page number to the plurality of page numbers.

20. A television viewing system, comprising:
a processor configured to facilitate the display of Teletext pages;
a Teletext page storage in electronic communication with the processor and configured to store the Teletext pages at page addresses;
an index in electronic communication with the processor, the index storing page numbers of the Teletext pages and corresponding ones of the page addresses, so as to facilitate determination by the processor of the page address associated with a particular one of the page numbers.

21. The television viewing system of claim 20 wherein the Teletext pages have image information for display of an image, wherein the Teletext page storage is configured to store the image information at the page addresses, and wherein the index is further configured to index the page numbers and the associated page addresses so as to facilitate rapid retrieval of the image information from the Teletext page storage.

22. The television viewing system of claim 21 wherein the index is a page number index further configured to store the page numbers in numerical order.

23. The television viewing system of claim 21 wherein the index is a sequential index further configured to store the page numbers in the order in which corresponding ones of the Teletext pages are received by the television viewing system.
